(19) United States
(12) Patent Application Publication
(10) Pub. No.: US 2014/0100928 A1
(43) Pub. Date: Apr. 10, 2014

(54) UPLOADABLE ADVERTISEMENT OBSERVATION AND RESPONSE GAME

(71) Applicant: Daxton Bernard Lyon, Honolulu, HI (US)

(72) Inventor: Daxton Bernard Lyon, Honolulu, HI (US)

(21) Appl. No.: 14/049,936

(22) Filed: Oct. 9, 2013

Related U.S. Application Data
(60) Provisional application No. 61/795,077, filed on Oct. 9, 2012.

(51) Int. Cl. G06Q 30/02

(52) U.S. Cl. CPC G06Q 30/0209; G06Q 30/0242
USPC 705/14.12

(57) ABSTRACT

An uploadable advertisement rating and response game which utilizes an onsite tournament structure wherein advertisers upload advertisements into a hardware and software platform. Users access the advertisements through a portal (such as website, desktop application, or mobile application) and review and respond to the advertisements in exchange for prizes.

This application claims the priority of U.S. provisional patent application No. 61/795,077 filed Oct. 9, 2012.

### TECHNICAL FIELD.

The present invention relates generally to interactive games offered through the Internet. Specifically, the invention relates to an Internet-based, uploadable, advertisement observation and response game that operates in a social media, web, desktop application and/or mobile application environment.

### BACKGROUND ART

Social media networks and mobile applications have become important parts of society and culture. However, they typically go through a life cycle. In order to gain popularity, social media networks and mobile applications are initially offered to users free of charge and without any advertisements. After they achieve substantial growth and popularity, advertisers want to reach the users of those social media networks or applications. Owners and developers of the social media networks and mobile applications also want to profit from their popularity by incorporating advertisements and charging additional costs. Consumers, however, typically dislike additional advertisements and/or additional costs and begin searching for free and advertisement-free alternatives. Thus, owners and developers of social media network and mobile applications have had difficulty creating advertising revenue streams without sacrificing the popularity of their social media networks and mobile applications. They have also had difficulty maximizing their advertising potential because users typically ignore advertisements, rendering them ineffective.

Solutions to this problem have taken different forms. For example, owners and developers have offered different versions of mobile applications—one free version with advertisements and one version without advertisements for a fee (such as, Pandora). However, this means that the applications are no longer offered free of charge and without advertisements, and it does not solve the problem of users who simply ignore the advertising.

Accordingly, it is an object of the present invention to develop an advertising experience that is fun and rewarding for users (including social media network users and mobile application users) by incentivizing them to voluntarily watch commercials and advertisements, and rate and respond to those commercials and advertisements, in exchange for points and prizes (e.g. money, rewards, awards, discounts, bonuses, rebates, gifts and coupons).

It is another object of the present invention to transform user responses into useful information for advertisers to evaluate the effectiveness of their advertisements and marketing messages, as well as the value of their products and brands.

### DISCLOSURE OF THE INVENTION

The above and other objects are preferably achieved by an Internet-based advertising platform that bundles advertisements (marketing messages that consist of one or more sounds, text, images, graphics and/or other audiovisual elements) provided by registered advertisers (marketing agencies, public relations agencies, wholesalers, retailers, manufacturers and/or other suppliers of advertisements) into advertiser-designed campaigns consisting of one or more advertisements. The campaigns are stored in a server, preferably in the cloud. The server formats and organizes the campaigns into tournaments and registered users can thereafter view and respond to the advertisements in a voluntary (conscious) or involuntary (subconscious) manner in exchange for points and prizes.

The above and other objects are also preferably achieved by a process comprising: advertiser registering a plurality of advertisers with a platform through an advertiser portal; enabling each of the advertisers to upload advertisements to the platform through the advertiser portal; user registering a plurality of users with the platform through a user portal; displaying the advertisements from the platform to the users on the users' Internet-connected devices through the user portal; allowing the users to provide responses to the advertisements; awarding points to a user based on a comparison of the user's response to an advertisement with previous users' responses to the advertisement; distributing prizes to the users based on points awarded; and providing information about the users' responses to evaluate effectiveness of the advertisements.

The process can preferably further include allowing the advertisers to create prizes. The prizes can be either money, rewards, awards, discounts, bonuses, rebates, gifts and coupons.

The advertiser portal and user portal are preferably either a website, a desktop application, or a mobile application. If the user portal is a website, it is preferably a part of a social networking site and it allows users to invite other users to register with the platform through the social networking site.

The Internet connected devices are preferably either computers or mobile devices. Advertisements preferably consist of sounds, text, graphics, and other audiovisual elements. User responses can be voluntary responses, involuntary responses, or both.

The above and other objects are preferably achieved by a downloadable computer-readable non-transitory file containing instructions that, when executed, cause a computer to become an advertisement observation and response game machine, comprising: software that: advertiser registers a plurality of advertisers with a platform through an advertiser portal; enables each of the advertisers to upload advertisements to the platform through the advertiser portal; user registers a plurality of users with the platform through a user portal; displays the advertisements from the platform to the users on the users' Internet connected devices through the user portal; allows the users to provide responses to the advertisements; awards points to a user based on a comparison of the user's response to an advertisement with previous users' responses to the advertisement; distributes prizes to the users based on points awarded; and provides information about the users' responses to evaluate effectiveness of the advertisements.

The above and other objects are also preferably achieved by a computer-readable non-transitory storage medium containing instructions that, when executed, cause a computer to become an advertisement observation and response game machine, comprising: software that: advertiser registers a plurality of advertisers with a platform through an advertiser portal; enables each of the advertisers to upload advertisements to the platform through the advertiser portal; user registers a plurality of users with the platform through a user portal; displays the advertisements from the platform to the users on the users' Internet connected devices through the user portal; allows the users to provide responses to the advertisements; awards points to a user based on a comparison of the user's response to an advertisement with previous users' responses to the advertisement; distributes prizes to the users based on points awarded; and provides information about the users' responses to evaluate effectiveness of the advertisements.

The above and other objects are also achieved by an article of manufacture comprising: a computer-readable non-transitory storage medium; software stored on the storage medium containing instructions that, when executed, make a computer into an advertisement observation and response game machine by: advertiser registering a plurality of advertisers with a platform through an advertiser portal; enabling each of the advertisers to upload advertisements to the platform through the advertiser portal; user registering a plurality of users with the platform through a user portal; displaying the advertisements from the platform to the users on the users' Internet-connected devices through the user portal; allowing the users to provide responses to the advertisements; awarding points to a user based on a comparison of the user's response to an advertisement with previous users' responses to the advertisement; distributing prizes to the users based on points awarded; and providing information about the users' responses to evaluate effectiveness of the advertisements.

The goal of the present invention is to gameify user observation of advertisements by incentivizing user observation and responses to the advertisements to obtain information on the effectiveness of the advertisements.

### BRIEF DESCRIPTION OF THE DRAWINGS

FIG. 1 is a code independent logic flow diagram of an exemplary embodiment of the present invention for users.

FIG. 2 is a code independent logic flow diagram of an exemplary embodiment of the present invention for advertisers.

### BEST MODE FOR CARRYING OUT THE INVENTION.

The presently preferred embodiment of the invention uses an onsite tournament structure, wherein advertisers upload advertisements (marketing messages that consist of one or more sounds, text, images, graphics and/or other audiovisual elements) into a server, preferably in the cloud through a portal (a website, desktop application, or mobile application). The cloud is networked enterprise storage wherein data is stored in virtualized pools of storage (servers). The portal is the entry point into the cloud whereby users gain access to a hardware and software platform (platform) of the present invention, the location where advertisements are stored and are viewable by users using an Internet connected device (such as a computer or mobile device). Users log into the present game through the portal and review and respond to the advertisements in exchange for points and prizes.

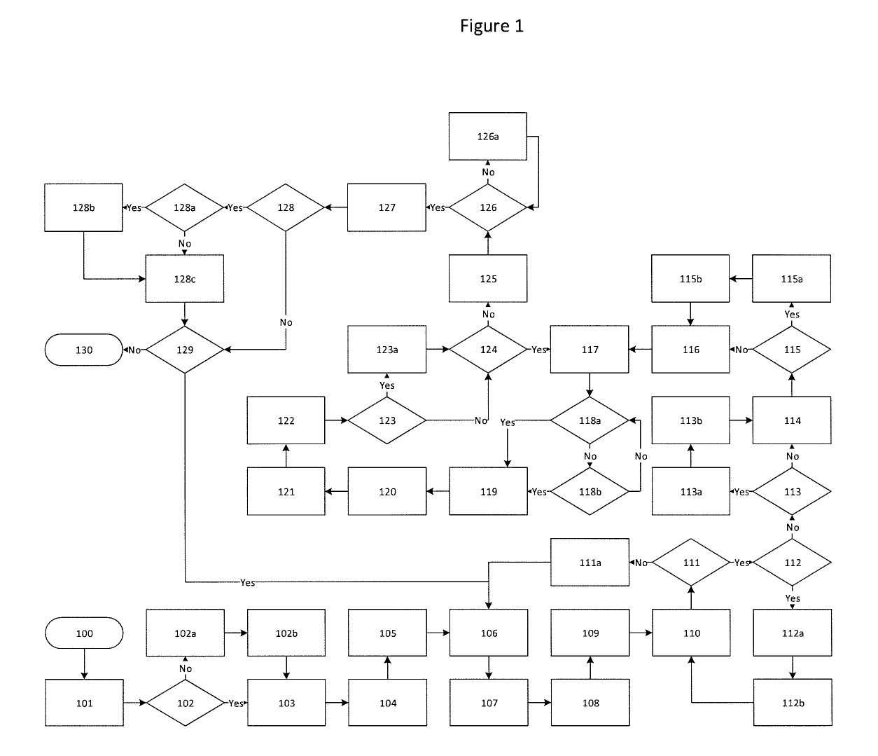

Referring to FIG. 1, at the start of the presently preferred embodiment of the invention 100, users can go to a portal (a website, desktop application, or mobile application) and access the present invention (the game) software in a server in the cloud using an Internet connected device (such as a computer or mobile device) 101.

If the portal is a website, it is preferably accessible through a social networking site (such as Facebook), or a commercial site (such as Games.com) using any Internet browser. If the portal is a mobile application, it is preferably accessible through an Android or iOS mobile device. On the other hand, if the portal is a desktop application, it is preferably accessible through the use of a computer and a desktop operating system, such as Windows, Linux, or OS X.

The present invention preferably gives the user the option to register 102. If a user has not registered, the user registers 102a and verifies his or her registration information 102b. Users can use a predefined registration form or a registration plugin to register. Users can also invite other users from among their social media networks to register and participate in the present invention.

Once a user is registered, he or she can log into the platform from the portal and select a tournament to participate in. Specifically, once registered, the user is allowed to log into the game 103 and is directed to a site information page 104. The user can then select a link to go to the game lobby 105 and is directed to the game lobby page 106. There the user locates a tournament menu in the game lobby 107 and can browse the tournament menu 108 and select a tournament to play 109. Once a tournament is selected, the tournament page opens 110. The user is given the option to continue with the selected tournament, or to discontinue with the tournament 111. The user can either close the tournament page 111a and go back to the game lobby page 106, or receive instructions on how to play the tournament 112 by opening the instructions menu and reviewing the instructions 112a. When finished, the user preferably closes the instructions menu 112b and is directed back to the tournament page 110.

Tournaments preferably consist of one or more campaigns, which themselves consist of one or more advertisements (marketing messages that consist of one or more sounds, text, images, graphics and/or other audiovisual elements). Advertisers supply the advertisements and design and build the campaigns. The server formats and organizes the campaigns into tournaments.

Every advertisement has a primary focus and is either related to a specific brand, a specific product, a specific feature, or a message, however, advertisements can consist of a combination of brand, product, feature, and message elements.

Campaigns can consist of a single advertisement. On the other hand, campaigns that consist of two or more advertisements are preferably organized in either a vertical or horizontal structure. Campaigns that are composed of three or more advertisements are preferably organized in a vertical, horizontal, or hybrid (vertical and horizontal) structure.

Vertical campaign structures are composed of a series of successive brand, product, feature, and message advertisements. Horizontal campaign structures are composed of either multiple brand, multiple product, multiple feature, or multiple message advertisements. Hybrid campaign structures are composed of both vertical and horizontal campaign structures.

For every tournament, the user's response can be voluntary or involuntary. Voluntary (conscious) responses (not described in FIG. 1) preferably include: (i) rating—when a user assigns a value, number, rank, and/or grade to the advertisement; (ii) comparison—when a user examines the character and/or quality of the advertisement and rates it against other advertisements; and (iii) feedback—when a user answers questions about the advertisement. Involuntary (subconscious) responses, such as heart rate, perspiration, eye movement, and temperature changes, can also be measured using appropriate devices, such as heart-rate monitors, perspiration meters, eye-tracking instruments, blood pressure apparatuses, respiratory machines, and thermometers. Involuntary responses may be more accurate than voluntary responses.

Referring to FIG. 1, in the presently preferred embodiment of the invention, the user is given the option to respond to advertisements using involuntary responses 113. If selected, the user opens the involuntary response settings menu and configures the type of involuntary responses that will be used and the devices that will record the involuntary responses 113a. When finished, the user closes the involuntary response settings menu 113b. Thereafter, the tournament will load 114.

The presently preferred embodiment of the invention also gives the user an opportunity to customize his or her game settings and options 115 by opening a game settings menu and configuring the settings and options 115a. Some examples of optional settings include: optional graphics, sounds, network options, and control options. Graphic options include (without limitation) options on color, brightness, contrast, screen-size, and screen resolution. Sound options include (without limitation) options regarding volume, equalizer settings, and using playback and recording devices. Network options include (without limitation) options on using network devices and connections with the present invention, and control options include (without limitation) options for using input devices, controllers, and configuration options for the input devices and controllers to be used with the game.

When finished, the user preferably closes the game settings menu 115b, and the server in the cloud will generate an advertisement from a campaign 116 for the user to respond to 117. The server in the cloud will verify the user's response settings to determine if the user is required to respond voluntarily 118a, involuntarily 118b, or both 118a and 118b. According to the response setting, the user will respond to the advertisement and the present invention will preferably record the user's response(s) (the user's reaction to the advertisements) 119. Each response travels to the cloud 120 and is stored in the server 121.

In the presently preferred embodiment of the invention, user responses that are favorable towards an advertisement in a campaign will result in the server providing more advertisements from that campaign to the user for further responses. As long as a campaign is a vertical or horizontal campaign, and the user continues to respond favorably to the advertisements in the campaign, the campaign will continue to run until it terminates. When a campaign has been exhausted, or the user responds to advertisements in the campaign negatively, the game will introduce another campaign to the user.

In the presently preferred embodiment of the invention, users play tournaments one at a time (although it is possible for users to have more than one tournament or type of tournament active simultaneously). The objective for every tournament is to score points (game points). Generally, the user who earns the most game points wins. Preferably, users earn the maximum number of game points when their responses match the majority of responses provided by previous users. However, every response receives points except for the least popular response. Thus, the more popular a response is (i.e. the more users select the same response), the more points that particular response is worth during a tournament.

Game points are preferably scored using running totals, wherein every time a user responds to an advertisement, the responses are totaled. The first user to respond to an advertisement establishes the precedent and scoring for the advertisement such that the first response always receives maximum game points. A response with the most tallies receives the most game points. A response with the least tallies receives no game points. The responses that are in between first and last place receive a progressive number of game points from next to last, up to second place. If the tally of two or more responses is the same, the response with the higher tally is valued greater than the response that ties the tally, until the response that ties the tally is greater than the response that had the higher tally first.

Alternatively, game points are scored using moving averages, wherein user responses are calculated in relation to a mean or median value. Responses that match the mean/median receive maximum game points. Responses that exceed a particular confidence interval and/or are outliers receive zero game points. The degree of deviation of a response from the mean or median value will determine the proportion of points a user receives in a decreasing manner. The first three users that respond to an advertisement collectively establish the mean or median value such that the first three responses always receive the maximum game points. Every subsequent user that responds to the advertisement will add one new value to the total number of responses by which that user will be measured and scored.

In the presently preferred embodiment of the invention, a user's response is scored and applied to the user playing in the tournament 122. After each response, the present invention preferably determines if the user has won one or more prizes. These prizes are awarded while the user is playing the game 123. The prizes are applied to the user's account and stored in the server in the cloud 123a. The present invention then determines if there is another advertisement for the user to view and respond to 124. If yes, then another advertisement will appear for viewing 117. If no, then the tournament page will close and user will enter the game lobby 125.

At this point, the present invention determines if the tournament is complete 126. If yes, the final tournament results are stored in the server 127. If not, the pending tournament results will be stored in the server temporarily 126a until the tournament is complete at which time the final results will replace the pending results.

Tournaments will conclude in a predetermined fashion according to any one, or combination, of the following conditions: (1) after a certain time limit, (2) after a certain number of advertisements have been viewed, (3) after a certain number of game points is reached, (4) according to user preferences, (5) according to advertiser preferences, or (6) randomly. Once a tournament is over, the following information is preferably displayed for the user to view: game points received statistics, responses given, and/or prizes received.

One or more players can receive final prizes from the final results of a tournament.

Winners are defined by each tournament and can include: (1) a certain fixed percentage of players in a tournament, (2) players who receive a certain number of minimum game points, (3) a specified number of players, or (4) some combination of the three options. Winners are offered prizes, such as money, rewards, awards, discounts, bonuses, rebates, gifts and coupons.

The present invention preferably determines if a user qualifies to win any final prizes 128. If yes, the present invention determines if the user has a choice of prizes 128a, and if so, the user is allowed to choose his or her prize 128b. Prizes are applied to the user's account in the server 128c. A user can also decide not to accept a prize and instead receive prize points that are equal to the value of the prize offered. Prize points can be exchanged for other prizes in the future.

Between the time that a user completes a tournament and the time that the present invention processes the final results of the tournament, the present invention preferably gives the user the option to continue using the game 129. If the answer is yes, the user is directed to the game lobby page 106. If the answer is no, then the game ends and the user logs off the platform 130.

User responses that are stored in the server in the cloud are preferably made available to advertisers in real-time and are thereafter transformed into reports containing statistical data, trends, and other information to evaluate the effectiveness of advertisers' advertisements and campaigns. The information can also be used to evaluate an advertiser's target market for their advertisement.

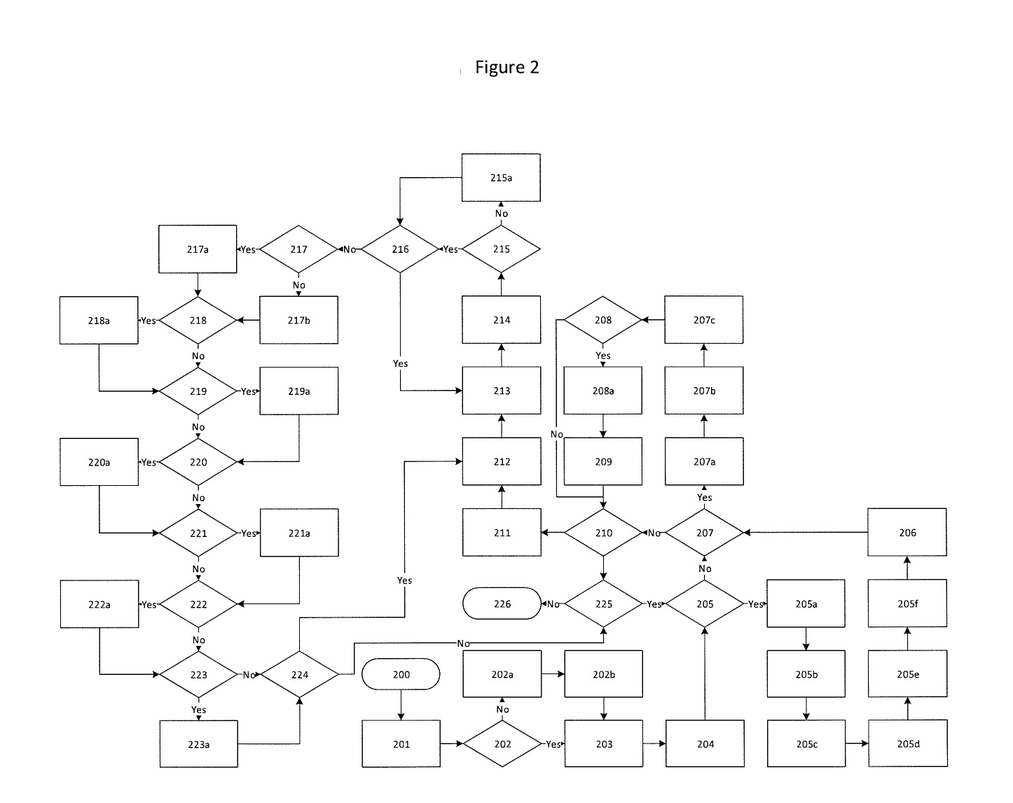

Advertisers' interactions with the presently preferred embodiment of the present invention differ from users. Referring to FIG. 2, the presently preferred embodiment of the invention begins at a starting point for advertisers 200, where they can go to a portal (a website, desktop application, or mobile application) and access the platform of the present invention in the server (preferably in the cloud) using an Internet connected device (such as a computer or mobile device) 201.

The present invention gives the advertiser the option to register for free or register for a fee 202. If selected, the advertiser registers 202a and verifies its registration information 202b. Advertisers can use a predefined registration form or a registration plugin to register. Once registered, or if the advertiser has already registered, the advertiser can log into the platform from a portal 203 and preferably upload, organize, and store its advertisements in the server in the cloud.

Once logged into the game, the advertiser preferably lands on a page 204, where the present invention gives the advertiser the option to (1) upload and store, or (2) share their advertisements with the server in the cloud 205. If the advertiser “uploads and stores” the advertisements, they are stored in the server in the cloud. If the advertiser chooses to “share” its advertisements, they are merely accessible from the advertiser's own computer or mobile device through a link. If the advertiser chooses the option to (1) upload and store, or (2) share, the advertiser selects a button 205a and is directed to a page where it can (1) upload and store, or (2) share its advertisements 205b. The advertiser then preferably opens a directory located on the advertiser's own computer or mobile device that contains its advertisements 205c. The advertiser opens the folder within the directory where its advertisements are stored 205d and selects an advertisement or advertisements from the existing storage folder 205e. The advertiser thereafter selects one of two buttons 205f that to (1) upload and store, or (2) share the selected advertisement or advertisements with the server in the cloud 206. These advertisements are preferably used to develop campaigns.

The presently preferred embodiment of the invention also preferably allows advertisers the option to create prizes (e.g. money, rewards, awards, discounts, bonuses, rebates, gifts and coupons) 207. Prizes are preferably created and stored in the server in the cloud. If the advertiser wants to create a prize, it selects a link 207a and is directed to a page where it can create a prize 207b. The advertiser can then design a prize 207c. The present invention gives the advertiser the option to save the prize 208 by selecting a button 208a. The prize is then saved in the server in the cloud 209.

The present invention also preferably gives the advertiser the option to create campaigns using one or more its advertisements 210. The advertiser can create a campaign by selecting a link 211 that directs it to a page where it can build (create and design) a campaign 212. To build a campaign, the advertiser selects one of its advertisements stored in (or shared with) the server in the cloud 213. The advertisement will load and be presented on the advertiser's computer screen or mobile device 214. The present invention determines if the advertiser has selected a layout for the advertisement 215. If no, the advertiser selects a layout 215a. If yes, the present invention determines if the selected layout requires any additional advertisements 216. If yes, the advertiser selects another one of its advertisements stored in (or shared with) the server 213. If no, the platform goes on to give the advertiser the option to determine if it will define or limit the user responses to the advertisements to voluntary responses, involuntary responses, or both types of responses 217. If the advertiser wishes to define the types of user responses, it can go ahead and select the type of responses that will be presented with the advertisement 217a. Otherwise, the present invention will default to allow users to define their own response methods 217b.

The presently preferred embodiment of the invention also gives advertisers the option to assign descriptive data, such as text, numbers, symbols, and signs, to their advertisements. The descriptive data preferably forms questions or makes statements about the advertisements 218. A user may or may not be able to answer, respond to, or otherwise interact with, the descriptive data. If descriptive data is desired, the advertiser can select an advertisement and apply descriptive data 218a.

Advertisers preferably build their campaigns by linking their advertisements together one advertisement at a time. Advertisements that are constructed vertically are preferably structured in a way that links an advertiser's brand, to one of the brand's products, to one of that product's features, and to a message for that product. However, any combination of brand, product, feature, and message can be used to form a vertical campaign. The advertiser can also link its brand to an array of products that are linked to an array of features and an array of messages.

The present invention gives the advertiser the option to add a vertical advertisement segment to its campaign 219 and adds the vertical advertisement segment if desired 219a. It also preferably gives the advertiser the option to add a horizontal advertisement segment to the campaign 220 and adds the horizontal advertisement segment if desired 220a.

The presently preferred embodiment of the invention preferably allows advertisers to associate one or more prizes to any of their advertisements within a campaign 221 by allowing the advertiser to select a link to add a prize 221a and select a corresponding prize to associate with an advertisement. These prizes are awarded to users at the time the user responds to the advertisement.

When complete, the present invention gives the advertiser the option to purchase the campaign so that it can be used in tournaments 222. Payment is accomplished when the advertiser selects a checkout button 222a. If the advertiser does not want to purchase the campaign at that time, the advertiser is given the alternative option to save the campaign 223 by selecting a save button and the campaign is then saved in the server in the cloud 223a.

Finally, the present preferred embodiment of the invention gives the advertiser the option to build another campaign 224. If the advertiser desires to build another campaign, then the advertiser is directed back to the page where it can create and design campaigns 212. If the advertiser is finished building campaigns, the present invention gives the advertiser the option to continue using the platform 225 and directs the advertiser to upload and store more advertisements to the advertiser's account in the server 205. If the advertiser no longer wishes to use the game software, the present invention ends 226 and the advertiser can log off from the game.

While the present invention has been disclosed in connection with the presently preferred embodiments described herein, it should be understood that there may be other embodiments which fall within this spirit and scope of the invention as defined by the claims. Accordingly, no limitations are to be implied or inferred in this invention except as specifically and as explicitly set forth in the claims.

### INDUSTRIAL APPLICABILITY

This present invention can be used whenever it is desirable to maximize user viewing and engagement with advertisements and commercials.

What is claimed is:

1. A process comprising:
advertiser registering a plurality of advertisers with a platform through an advertiser portal;
enabling each of said advertisers to upload advertisements to said platform through said advertiser portal;
user registering a plurality of users with said platform through a user portal;
displaying said advertisements from said platform to said users on said users' Internet-connected devices through said user portal;
allowing said users to provide responses to said advertisements;
awarding points to a user based on a comparison of said user's response to an advertisement with previous users' responses to said advertisement;
distributing prizes to said users based on points awarded; and
providing information about said users' responses to evaluate effectiveness of said advertisements.

2. A process according to claim 1, further comprising allowing said advertisers to create prizes.

3. A process according to claim 1, wherein said advertiser portal is a website.

4. A process according to claim 1, wherein said advertiser portal is desktop application.

5. A process according to claim 1, wherein said advertiser portal is a mobile application.

6. A process according to claim 1, wherein said user portal is a website.

7. A process according to claim 1, wherein said user portal is desktop application.

8. A process according to claim 1, wherein said user portal is a mobile application.

9. A process according to claim 1, wherein said Internet connected devices are selected from the group consisting of computers or mobile devices.

10. A process according to claim 6, wherein said website is a part of a social networking site.

11. A process according to claim 10, wherein said user portal allows said users to invite other users to register with said platform through said social networking site.

12. A process according to claim 1, wherein said advertisements consist of sounds, text, graphics, and other audiovisual elements.

13. A process according to claim 1, wherein said user responses are selected from the group consisting of voluntary or involuntary responses.

14. A process according to claim 1, wherein said prizes can be selected from the group consisting of money, rewards, awards, discounts, bonuses, rebates, gifts and coupons.

15. A downloadable computer-readable non-transitory file containing instructions that, when executed, cause a computer to become an advertisement observation and response game machine, comprising:
software that:
advertiser registers a plurality of advertisers with a platform through an advertiser portal;
enables each of said advertisers to upload advertisements to said platform through said advertiser portal;
user registers a plurality of users with said platform through a user portal;
displays said advertisements from said platform to said users on said users' Internet connected devices through said user portal;
allows said users to provide responses to said advertisements;
awards points to a user based on a comparison of said user's response to an advertisement with previous users' responses to said advertisement;
distributes prizes to said users based on points awarded; and
provides information about said users' responses to evaluate effectiveness of said advertisements.

16. A computer-readable non-transitory storage medium containing instructions that, when executed, cause a computer to become an advertisement observation and response game machine, comprising:
software that:
advertiser registers a plurality of advertisers with a platform through an advertiser portal;
enables each of said advertisers to upload advertisements to said platform through said advertiser portal;
user registers a plurality of users with said platform through a user portal;
displays said advertisements from said platform to said users on said users' Internet connected devices through said user portal;
allows said users to provide responses to said advertisements;
awards points to a user based on a comparison of said user's response to an advertisement with previous users' responses to said advertisement;
distributes prizes to said users based on points awarded; and
provides information about said users' responses to evaluate effectiveness of said advertisements.

17. An article of manufacture comprising:
a computer-readable non-transitory storage medium;
software stored on said storage medium containing instructions that, when executed, make a computer into an advertisement observation and response game machine by:
advertiser registering a plurality of advertisers with a platform through an advertiser portal;
enabling each of said advertisers to upload advertisements to said platform through said advertiser portal;
user registering a plurality of users with said platform through a user portal;
displaying said advertisements from said platform to said users on said users' Internet-connected devices through said user portal;
allowing said users to provide responses to said advertisements;
awarding points to a user based on a comparison of said user's response to an advertisement with previous users' responses to said advertisement;
distributing prizes to said users based on points awarded; and
providing information about said users' responses to evaluate effectiveness of said advertisements.
